(19) United States
(12) Patent Application Publication
(10) Pub. No.: US 2025/0201231 A1
(43) Pub. Date: Jun. 19, 2025

(54) GENERATING SPEAKER VIDEO AND AUDIO IN MULTIPLE LANGUAGES FOR VIDEOCONFERENCING

(71) Applicant: Zoom Video Communications, Inc., San Jose, CA (US)

(72) Inventors: Yuhui Chen, San Jose, CA (US); Qiang Gao, Charlotte, NC (US); Zhaofeng Jia, Saratoga, CA (US)

(21) Appl. No.: 18/543,795

(22) Filed: Dec. 18, 2023

(51) Int. Cl. G10L 13/033; G10L 15/00; H04N 7/14; H04N 7/15

(52) U.S. Cl. CPC G10L 13/033; G10L 15/005; H04N 7/147; H04N 7/15

(57) ABSTRACT

Systems and methods for generating speaker video and audio in multiple languages for videoconferencing are provided. For example, a computing device can access a speaker speech audio signal that includes a speaker speech in a first language, a video of the speaker and a translated speech audio signal of the speaker speech in a second language. The computing device generates, based on the translated speech audio signal, a converted translated speech audio signal that includes a speech in the second language having voice characteristics in the speaker speech. The computing device further generates a lip-synched speaker video based on the video of the speaker and the converted translated speech audio signal. Lip movements in the lip-synched speaker video correspond to the converted translated speech audio signal. The converted translated speech audio signal and the lip-synched speaker video are transmitted to a video conference provider configured to host the video conference.

### FIELD

The present application generally relates to videoconferencing, and more particularly relates to generating speaker video and audio in multiple languages for videoconferencing.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to certain aspects described herein.

FIG. 2 shows an example system in which a chat and video conference provider provides videoconferencing functionality to various client devices, according to certain aspects described herein.

FIG. 3 shows an example of a user interface configured to display a consent authorization window for a user who has engaged in a video conference to interact with and to select options to use an available optional AI feature, according to certain aspects of the present disclosure.

FIG. 4 shows an example of an operating environment for generating speaker video and audio in multiple languages for videoconferencing, according to certain aspects of the present disclosure.

FIG. 5 shows a block diagram of the models used in generating speaker video and audio in multiple languages for videoconferencing, according to certain aspects of the present disclosure.

FIG. 6 shows an example of a block diagram of an audio conversion model for generating speaker video and audio in multiple languages for videoconferencing, according to certain aspects of the present disclosure.

FIG. 7 shows an example of a block diagram of a video conversion model for generating speaker video and audio in multiple languages for videoconferencing, according to certain aspects of the present disclosure.

FIG. 8 shows an example of a user interface of a video conference application used by participants to join a video conference, according to certain aspects of the present disclosure.

FIG. 9 shows a flowchart depicting a process for generating speaker video and audio in multiple languages for videoconferencing, according to certain aspects of the present disclosure.

FIG. 10 shows a flowchart depicting a process for generating converted translated speech audio signal for videoconferencing, according to certain aspects of the present disclosure.

FIG. 11 shows a flowchart depicting a process for generating lip-synched speaker video for videoconferencing, according to certain aspects of the present disclosure.

FIG. 12 shows an example computing device suitable for performing certain aspects of the present disclosure.

### DETAILED DESCRIPTION

Examples are described herein in the context of systems and methods for generating speaker video and audio in multiple languages for videoconferencing. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Videoconferencing has become a common way for people to meet as a group, but without being at the same physical location. Participants can be invited to a videoconference meeting, join from their personal computers or telephones, and are able to see and hear each other and converse largely as they would during an in-person group meeting or event. The advent of user-friendly videoconferencing software has enabled teams to work collaboratively despite being dispersed around the country or the world. It has also enabled families and friends to engage with each other in more meaningful ways, despite being physically distant from each other.

For video conferences with simultaneous interpretation mode enabled, interpreters perform real-time translations of the speaker's speech into another language. This allows participants to understand the content, but it introduces a few challenges. During these sessions, participants hear the interpreter's voice while observing the speaker's lip movements. Consequently, participants may notice discrepancies between the voice and the lip movement. Furthermore, the interpreter's voice characteristics such as intonation and timbre differ from the voice characteristics of the speaker, creating the sensation of a mediator standing between the speaker and the listener, assisting in communication.

To solve the above problems, example systems and methods for generating speaker video and audio in multiple languages for videoconferencing are provided. As described herein, an audio conversion model and a video conversion model can be used to generate a translated speech in a second language with the voice characteristics of the speaker (referred to as “converted translated speech audio signal” or “converted translated speech” in short) and a video of the speaker with lip movement matching the translated speech in the second language (referred to herein as “lip-synched speaker video”), respectively.

For example, an audio signal containing a speech in a second language translated from the speaker's speech (referred to herein as “translated speech audio signal” or “translated speech”) can be obtained. The translated speech audio signal may be an interpreter's speech audio signal transmitted from a computing device associated with the interpreter via a video conference provider configured to host the video conference. The translated speech audio signal may also be generated by a text-to-speech system based on text translated from the speaker's speech. The translated speech audio signal can be provided to an audio conversation model which includes an audio encoder and a voice changer model trained for the speaker. The voice encoder is configured to encode the translated speech audio signal into values that represent voice characteristics, such as the voice intonation and timbre. The voice changer model is configured to convert the input voice characteristics into voice characteristics of the speaker and output a speech audio carrying the converted voice characteristics. To generate converted translated speech, the voice changer model can be trained using speech audio signals of the speaker and thus can change the input voice characteristics to the speaker's voice characteristics.

In some examples, the voice changer model may not change the fundamental frequency of the input speech. Yet the fundamental frequencies of different speakers (e.g., female speakers and male speakers) can be very different. To address this issue, the audio conversion model can further include a fundamental frequency determiner to determine the fundamental frequency of the input translated speech. Further, during the training of the voice changer model, the fundamental frequency of the speaker can be calculated from the training speaker speech audio signals and be associated with the voice changer model. Based on the fundamental frequencies of the input translated speech audio signal and the speaker speech, the audio conversion model can shift the fundamental frequency of the output audio of the voice changer model to generate converted translated speech audio signal.

The converted translated speech audio signal can be input to a video conversion model to modify the speaker video to generate lip-synched speaker video. The video conversion model can be configured to extract speech features from the converted translated speech audio signal, such as spectrogram or other speech features in the frequency domain. The video conversion model can further identify the mouth region of the speaker video and employ a wave to lip model to generate lip-synched mouth region based on the speech features and the identified mouth regions. The lip-synched mouth region can be inserted back to the speaker video by the video conversion model to generate the lip-synched speaker video.

In some examples, because the mouth region input that can be accepted by the wave to lip model has specific resolution requirements, the identified mouth region of the speaker video needs to be re-sampled to match the input resolution of the wave to lip model. In some examples, the input of the wave to lip model requires a lower resolution and thus the identified mouth region can be down sampled to match the input resolution. To reduce the artifacts around the mouth region of the lip-synched speaker video, the input mouth region can be enlarged by a pre-determined number of pixels before being provided to the wave to lip model. The wave to lip model outputs a video of the mouth region where the lip movements match the content of the converted translated speech. The video conversion model can further merge the output mouth region with the rest of the speaker video to generate lip-synched speaker video. The lip-synched speaker video along with the converted translated speech audio signal can be transmitted to the participants who have selected this particular second language. As a result, these participants can listen to the speaker's speech in the second language and with the speaker's voice characteristics (as if the speaker was giving the speech in the second language) and watch the lip-synched speaker video whose lip movement matches the speaker's speech in the second language. The above process can be repeated for other languages.

As described herein, certain embodiments provide improvements to videoconferencing by generating speaker video and audio in multiple languages. The online nature of videoconferencing allows the audio and video perceived by the participants to be replaced with the audio and video of the speaker in a corresponding language selected by the individual participants. This eliminates communication barriers, creating a seamless and connected experience for the listener which enhances the user experience and fosters more effective communication between all parties involved. These improvements increase the meeting efficiency and reduce the need for following-up meetings thereby saving computing, storage, and network resources for hosting these meetings.

This illustrative example is given to introduce the reader to the general subject matter discussed herein and the disclosure is not limited to this example. The following sections describe various additional non-limiting examples and examples of systems and methods for active speaker detection for videoconferencing.

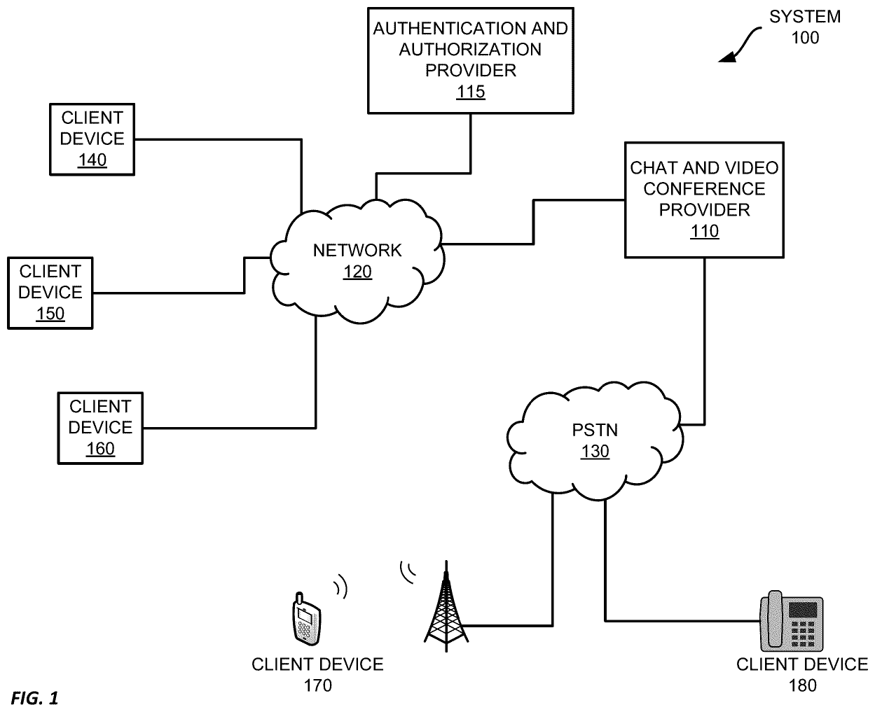

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

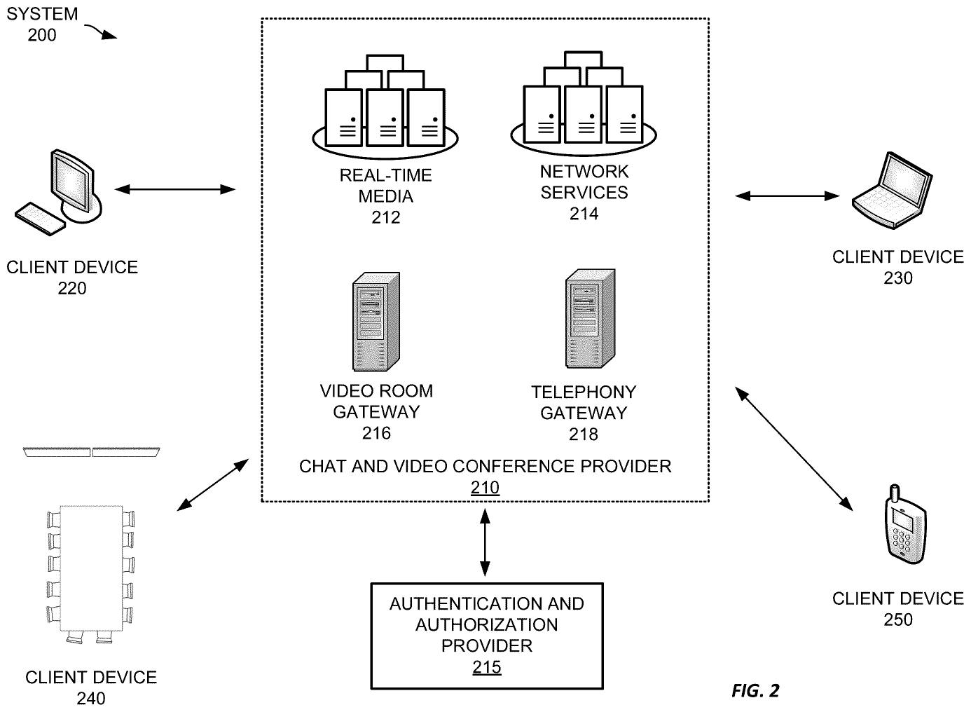

Chat and video conference provider 110 allows clients to create videoconference meetings (or “meetings”) and invite others to participate in those meetings as well as perform other related functionality, such as recording the meetings, generating speech transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example, encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryptions may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples, additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some examples according to the present disclosure, a user may select an option to use one or more optional AI features available from the virtual conference provider. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to provide training data for the underlying AI models, the user may be provided with an option to consent, or deny consent, to access and use some or all of the user's personal information. In general, the goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default account owners and administrators control whether to enable these AI features for their accounts, and if enabled, individual users may determine whether to provide consent to use their personal information.

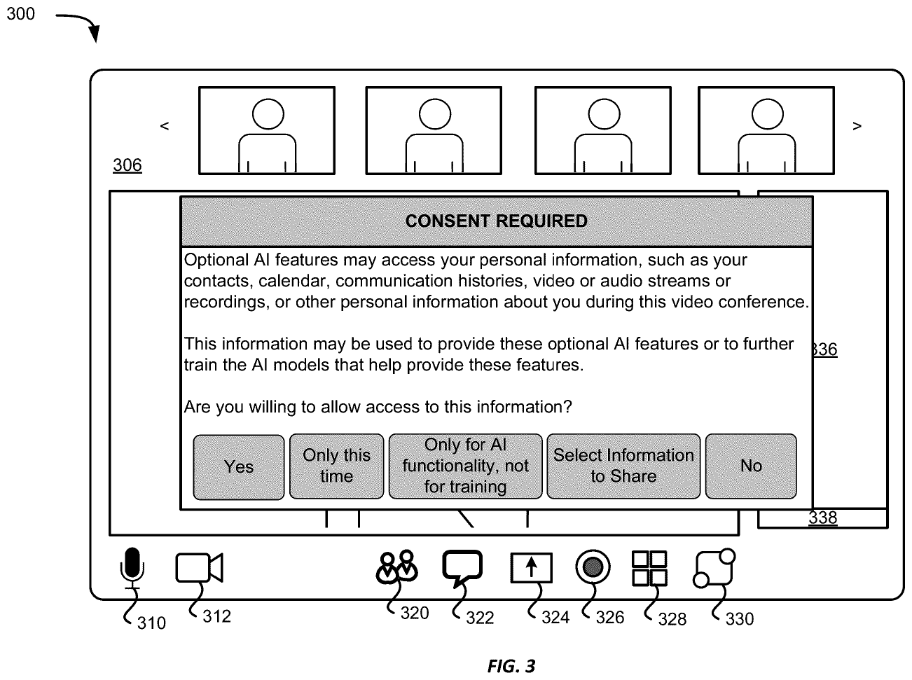

As can be seen in FIG. 3, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

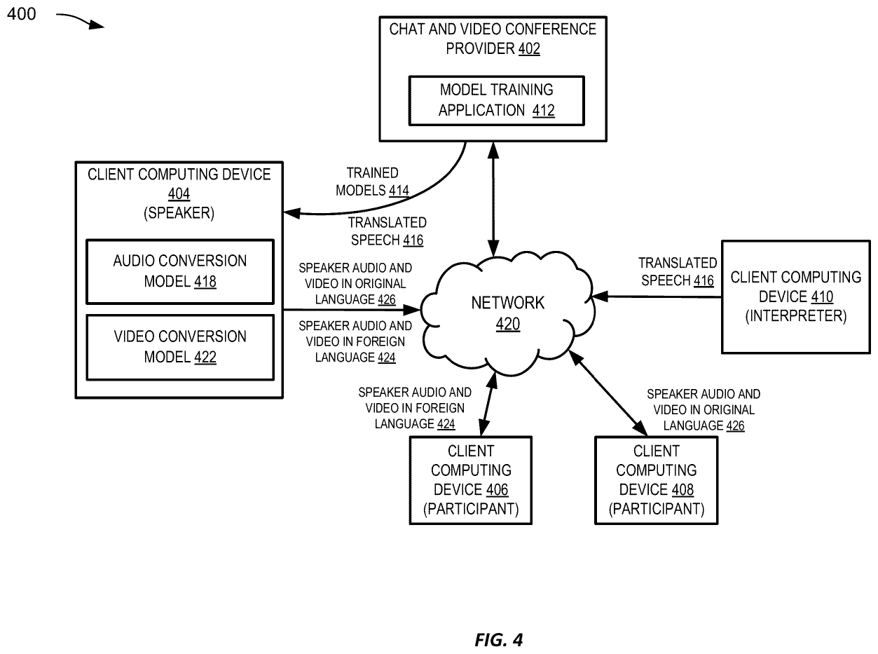

Referring now to FIG. 4, FIG. 4 shows an example of an operating environment 400 for generating speaker video and audio in multiple languages for videoconferencing, according to certain aspects of the present disclosure. As shown in FIG. 4, a chat and video conference provider 402 is configured to host a video conference among participants. The chat and video conference provider 402 may be the chat and video conference provider 110 or 210 discussed above with respect to FIGS. 1 and 2, respectively. The chat and video conference provider 402 is in communication with client computing devices associated with the participants of the video conference, such as a client computing device 404 associated with a speaker of the video conference (also referred to as a speaker client computing device 404), a client computing device 406 associated with a participant who has selected to receive the audio in a foreign language, and a client computing device 408 associated with a participant who has selected to receive the audio signal in the original language used by the speaker. The environment 400 further includes a client computing device 410 (also referred to as an interpreter client computing device 410) associated with an interpreter of the conference who will provide translation for the speaker's speech.

In some implementations, the chat and video conference provider 402 is also configured to train the models used in the translated speaker audio and video generation, such as an audio conversion model 418 and a video conversion model 422. To do so, the chat and video conference provider 402 can include a model training application 412 to train these models. The training can be performed, for example, by using speech signals of the speaker. The client computing device 404 or another client computing device associated with the speaker can send training speech audio signals of the speaker to the model training application 412. These training speech audio signals can be used to train the audio conversion model 418 so that the audio conversion model 418 can convert voice characteristics of an input audio signal to the voice characteristics of the speaker. Additional details about the training of the models will be discussed below with respect to FIG. 5-7. The chat and video conference provider 402 can transmit the trained models 414 (including the audio conversion model 418 and the video conversion model 422) to the speaker client computing device 404. In some implementations, the chat and video conference provider 402 is configured to delete the trained models 414 after the transmission.

As the video conference starts, the client computing device 404 can start recording the speaker's speech and capturing the video of the speaker and send the speaker audio and video in the original language 426 to other client computing devices. In some examples, the speaker audio and video in the original language 426 is transmitted via the chat and video conference provider 402. For example, the chat and video conference provider 402 can receive the speaker audio and video in the original language 426 from the client computing device 404 and transmit them to the client computing device 408.

For participants who have subscribed to a foreign language channel of the conference, the chat and video conference provider 402 transmits the speaker audio and video in the original language 426 to the client computing device 410 associated with the interpreter who can translate the speaker speech in the foreign language. The client computing device 410 captures the translated speech 416 and transmits it to the chat and video conference provider 402. The chat and video conference provider 402 forwards the translated speech 416 to the speaker client computing device 404.

The speaker client computing device 404 can employ the audio conversion model 418 to convert the translated speech 416 to a converted translated speech audio signal that matches the voice characteristics of the speaker. In addition, the speaker client computing device 404 can employ the video conversion model 422 to convert the video of the speaker to a lip-synched speaker video where the lip movements match the converted translated speech. Additional details about generating the speaker video and audio will be provided below with respect to FIGS. 5-11. The generated converted translated speech audio signal and lip-synched speaker video can be transmitted to client computing device 406 as the speaker audio and video in foreign language 424.

Some participants of the video conference may subscribe to another foreign language channel. In that case, the computing environment 400 may further include the client computing devices associated with those participants and the interpreter for this additional foreign language. The speaker client computing device 404 can use the audio conversion model 418 and the video conversion model 422 to generate the speaker audio and video for this additional foreign language as described above.

It should be understood that FIG. 4 is presented as an example computing environment and should not be construed as limiting. Various other ways of generating speaker video and audio in multiple languages for videoconferencing may be implemented. For example, the model training application 412 may be implemented on other devices than the chat and video conference provider 402. The translated speech 416 may be generated without relying on an interpreter. For instance, the speaker audio can be converted to text using automatic speech recognition (ASR) technology and the converted text may be translated to the foreign language through machine translation. The translated text can be converted to a speech audio signal to generate the translated speech 416. In that case, the interpreter does not need to participate in the meeting. Furthermore, generating the speaker audio and video in a foreign language 424 may be performed on the chat and video conference provider 402 rather than the speaker client computing device 404. Likewise, the model training may also be performed on the speaker client computing device 404, rather than the chat and video conference provider 402. Various other implementations may be possible.

Referring now to FIG. 5, FIG. 5 shows a block diagram of the models used in generating speaker video and audio in multiple languages for videoconferencing, according to certain aspects of the present disclosure. As shown in FIG. 5, two models are used to generate the speaker video and audio in a language different from the original language: an audio conversion model 502 (e.g., the audio conversion model 418) and a video conversion model 504 (e.g., the video conversion model 422). A translated speech 506 that contains audio signal of a translated version of the speaker's speech in a second language can be provided to the audio conversion model 502. The audio conversion model 502 can change the voice characteristics of the translated speech 506 according to the speaker's voice characteristics to generate the converted translated speech 508. The converted translated speech 508 contains an audio signal of the translated version of the speaker's speech with voice characteristics of the speaker. In other words, to a listener, the converted translated speech 508 sounds like the speaker is giving the same speech using the second language.

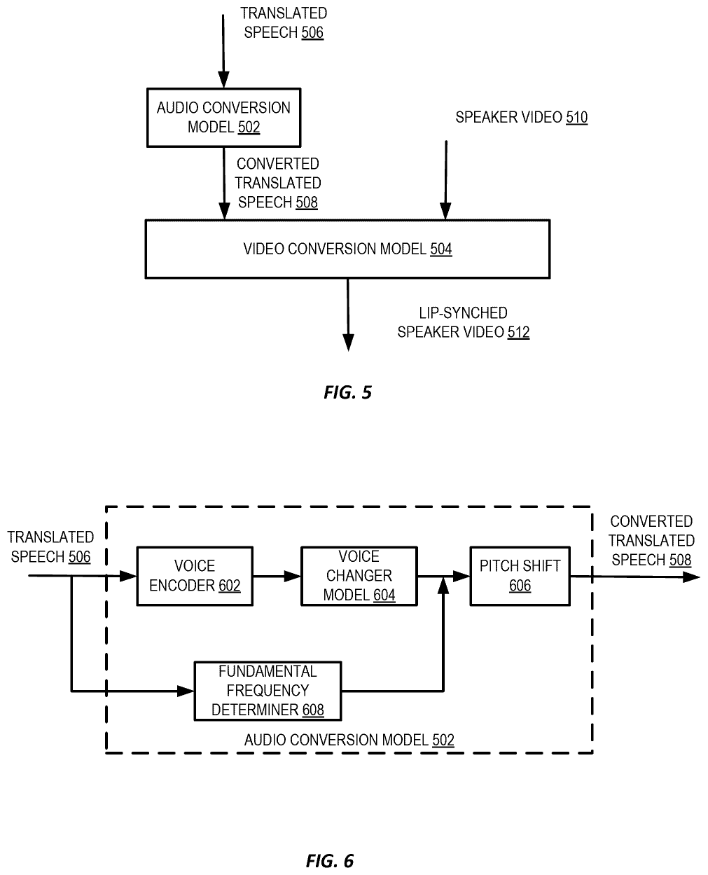

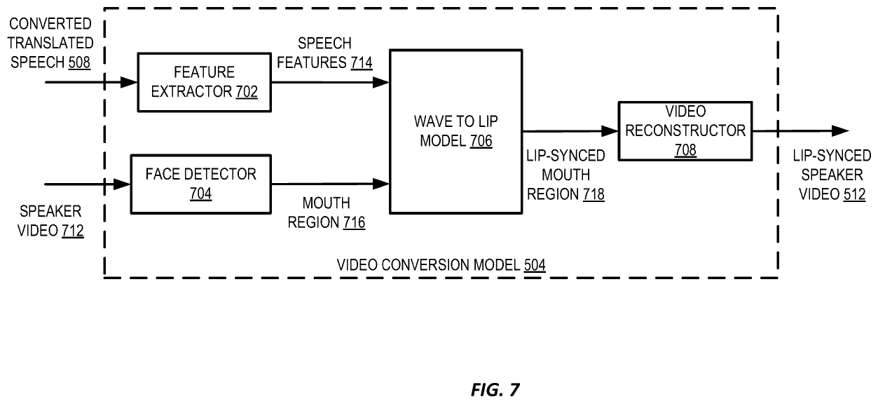

The converted translated speech 508 can be input to a video conversion model 504 along with a speaker video 510 containing video of the speaker giving the speech in the original language. Based on the converted translated speech 508 and the speaker video 510, the video conversion model 504 can generate a lip-synched speaker video 512 where the lip movements of the speaker are consistent with the audio signal in the converted translated speech 508. Additional details about the audio conversion model 502 and the video conversion model 504 are provided below with respect to FIGS. 6 and 7.

FIG. 6 shows an example of a block diagram of the audio conversion model 502 for generating speaker video and audio in multiple languages for videoconferencing, according to certain aspects of the present disclosure. The audio conversion model 502 shown in FIG. 6 includes a voice encoder 602 and a voice changer model 604. The voice encoder 602 is configured to encode the translated speech 506 into values that represent voice characteristics, such as the voice intonation and timbre. Example models that can be used as the voice encoder 602 include, but are not limited to, the Wav2Vec2 model, the Hubert model, the Whisper model, the ContentVec model, and the Conformer model. In some examples, the translated speech 506 is preprocessed, such as resampled, in order to provide it to the voice encoder 602 as an input. The voice encoder extracts voice characteristics of the input speech while preserving the content and language characteristics of the speech.

The voice changer model 604 trained for a speaker is configured to convert the input voice characteristics into the speaker's voice characteristics and output a speech audio carrying the converted voice characteristics emulating the speaker's voice. Example models that can be used as the voice changer model 604 include, but are not limited to, the WaveGlow model, the HiFi-GAN model, and the Mel-GAN model. To generate converted translated speech, the voice changer model 604 can be trained using training data containing speech audio signals of the speaker. Typically, high quality training data can yield models with better performance. As such, quality assessment can be performed on the training data to evaluate the audio quality before the training data are used to train the voice changer model. The quality assessment can be based on, for example, Mean Opinion Score (MOS), Perceptual Objective Listening Quality Analysis (POLQA), or deep learning model-based approaches. The models used in the deep learning model-based approaches can include a convolutional neural network (CNN), a recursive neural network (RNN), a long short-term memory (LSTM), and gated recurrent units (GRU).

If the audio quality of the training data falls below a recommended standard (e.g., below a pre-determined threshold value of audio quality), the audio quality of the training data can be enhanced, such as by applying denoising and dereverberation to the audio data. Additionally, or alternatively, a request for new training data may be sent to the client computing device or other devices associated with the speaker to collect audio signals of the speaker that have better quality. The request can specify the quality of the microphone and the environment for recording the new training data. The enhanced or re-collected training data can be used to train the voice changer model 604.

To train the voice changer model 604, training data can be input to the voice encoder 602 to generate voice characteristics. If needed, the training data can be pre-processed, such as resampled, to meet the input requirements of the voice encoder 602. The output of the voice encoder 602 is used as the training input to the voice changer model 604. The parameters of the voice changer model 604 are iteratively adjusted so that a loss function defined based on a difference between the output of the voice changer model and the training data is minimized. As a result of the training, the voice changer model 604 can output an audio signal by changing the voice characteristics of the input speech to the voice characteristics of the speaker without changing the content and language characteristics of the speech.

In some examples, the voice changer model may not change the fundamental frequency of the input speech. Yet the fundamental frequencies of different speakers (e.g., female speakers and male speakers) can be very different. To address this issue, the audio conversion model 502 further includes a fundamental frequency determiner 608 to determine the fundamental frequency F0 of the input translated speech 506. In some examples, the fundamental frequency determiner 608 can be implemented using audio digital signal processing techniques, such as pitch detection algorithms, pitch tracking algorithm, cepstral analysis, subharmonic-to-harmonic ratio (SHR), and so on. In other examples, the fundamental frequency determiner 608 can be implemented using a machine learning model, such as a support vector machine (SVM), a CNN, an RNN, a convolutional recurrent neural network (CRNN), and so on. Further, during the training of the voice changer model, the fundamental frequency F0 of the speaker can be calculated from the training speaker speech audio signals and be associated with the voice changer model 604. Based on the fundamental frequencies of the input translated speech audio signal and the speaker speech, a pitch shift module 606 of the audio conversion model 502 can shift the fundamental frequency F0 of the output audio of the voice changer model 604 to align with the fundamental frequency F0 of the speaker to generate converted translated speech audio signal 508.

FIG. 7 shows an example of a block diagram of a video conversion model 504 for generating speaker video and audio in multiple languages for videoconferencing, according to certain aspects of the present disclosure. In the example shown in FIG. 7, the video conversion model 504 includes a feature extractor 702, a face detector 704, a wave to lip model 706, and a video reconstructor 708. The feature extractor 702 is configured to extract speech features 714 from the converted translated speech 508 generated by the audio conversion model 502. In some examples, the speech features 714 are frequency domain features of the converted translated speech 508, such as spectrogram, mel spectrogram, bark spectrogram. The feature extractor 702 may have a specific resolution requirement for the input signal. In that case, the converted translated speech 508 is resampled to match the input resolution before being fed into the feature extractor 702.

The face detector 704 is configured to identify the mouth region 716 in the speaker video 712. The face detector 704 detects and tracks the facial features in the speaker video 712 using face detection techniques and outputs the mouth region. The speech features 714 and the identified mouth region 716 can be input to the wave to lip model 706 to generate lip-synched mouth region 718 which can be inserted back to the speaker video by the video reconstructor 708 to generate the lip-synched speaker video 512.

In some examples, because the wave to lip model 706 has specific resolution requirements for the input video, the identified mouth region 716 of the speaker video 712 needs to be re-sampled to match the input resolution of the wave to lip model 706. In some examples, the input of the wave to lip model 708 has a lower resolution and thus the identified mouth region 716 needs to be down sampled to match the input resolution. To reduce the artifacts around the mouth region 716 of the lip-synched speaker video, the mouth region 716 can be enlarged by a predetermined number of pixels before being provided to the wave to lip model 706. For example, the mouth region 716 can be enlarged or expanded by 5 pixels along four directions (left, right, upper, and lower) to generate the input to the wave to lip model 706.

The wave to lip model 706 is configured to, based on the lip region and the speech features, output a video of the mouth region where the lip movements match the audio content. The wave to lip model 706 can be a Wave2Lip model, LipGAN model, Deep Lip Sync model with CNNs or CNN and LSTM combination. The video reconstructor 708 can merge the lip-synched mouth region 718 with the rest of the speaker video 712 to generate lip-synched speaker video 512. The merging can include, for example, a linear or non-linear combination of the pixels at the border of the lip-synched mouth region 718 with the corresponding pixels in the speaker video 712 to reduce noticeable artifacts in the lip-synched speaker video 512. Further, because of the expansion of the mouth region, any remaining merging artifacts would appear outside the detected mouth region. Since the participants typically focus on the mouth region, these artifacts become less noticeable.

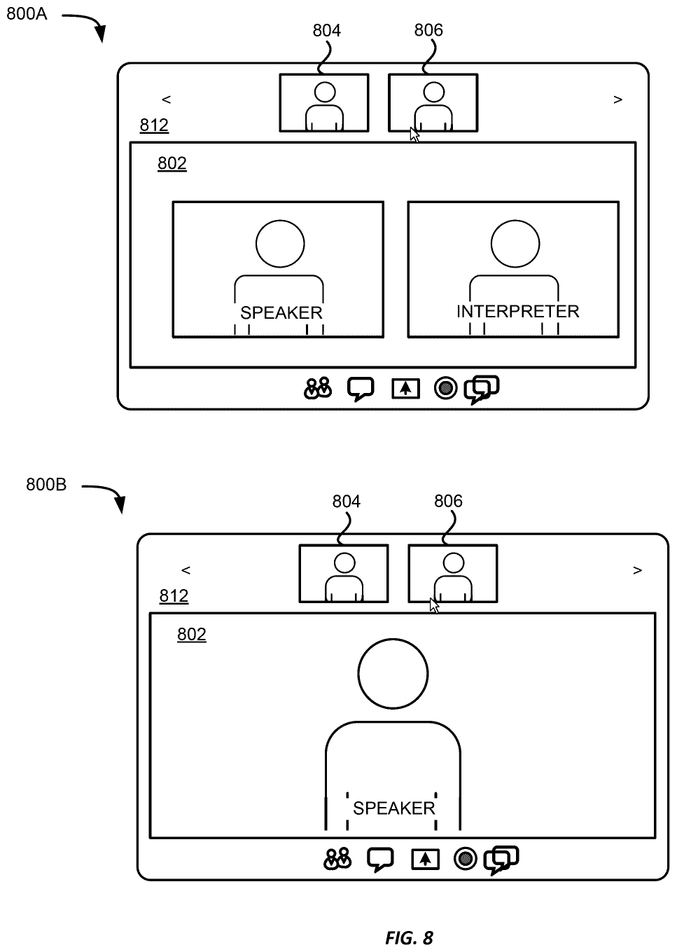

FIG. 8 shows an example of a user interface of a video conference application used by participants to join a video conference, according to certain aspects of the present disclosure. In this example, the user interface includes a primary display area 802 showing the video of the speaker(s) and a secondary display area 812 showing the videos of the remaining participants 804 and 806. The user interface 600 further includes a tool area at the bottom showing the icons of various tools that can be invoked for the video conferencing, such as the chat tool, the tool for displaying the participant list, the tool for sharing screen, the tool for recording the meeting, and the tools for configuring the microphone and the camera of the client computing device.

In FIG. 8, user interfaces 800A and 800B show the user interface of the video conference application before and after the technology disclosed herein is used, respectively. As can be seen from the user interface 800A, without using the technology presented herein, the primary display area 802 is divided into two portions, one for the speaker video and one for the interpreter video. By generating speaker video and audio in another language, the primary display area 802 can be dedicated to the speaker video as shown in user interface 800B, thereby allowing the participants to focus on the video conference and improving the efficiency of video conference.

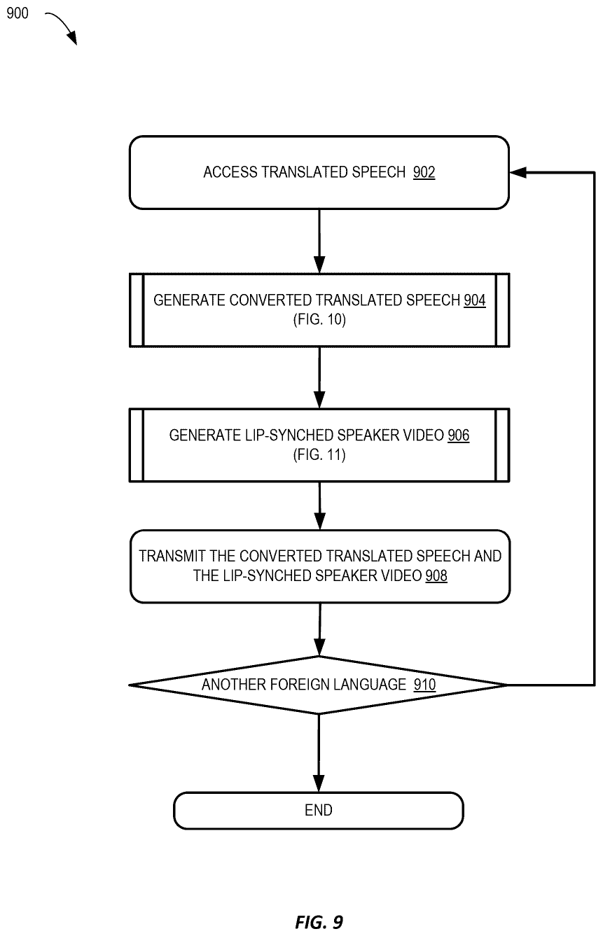

FIG. 9 shows a flowchart depicting a process 900 for generating speaker video and audio in multiple languages for videoconferencing, according to certain aspects of the present disclosure. The speaker client computing device 404 or another computing device can be configured to implement operations depicted in FIG. 9 by executing suitable program code. The software or program code may be stored on a non-transitory storage medium (e.g., on a memory device). The process depicted in FIG. 9 and described below is intended to be illustrative and non-limiting. Although FIG. 9 depicts the various processing blocks occurring in a particular sequence or order, this is not intended to be limiting. In certain alternative embodiments, the blocks may be performed in some different order, or some blocks may also be performed in parallel. For illustrative purposes, the process 900 is described with reference to certain examples depicted in the figures. Other implementations, however, are possible.

At block 902, the process 900 involves accessing translated speech of the speaker audio in a foreign language. As discussed above, the translated speech may be captured at the interpreter client computing device 410 and transmitted to the chat and video conference provider 402. The chat and video conference provider 402 can forward the translated speech to the speaker client computing device. In alternative or additional examples, the speaker audio can be converted to text using ASR technology and the converted text may be translated to the foreign language using machine translation. The translated text can be converted to a speech audio signal to generate the translated speech.

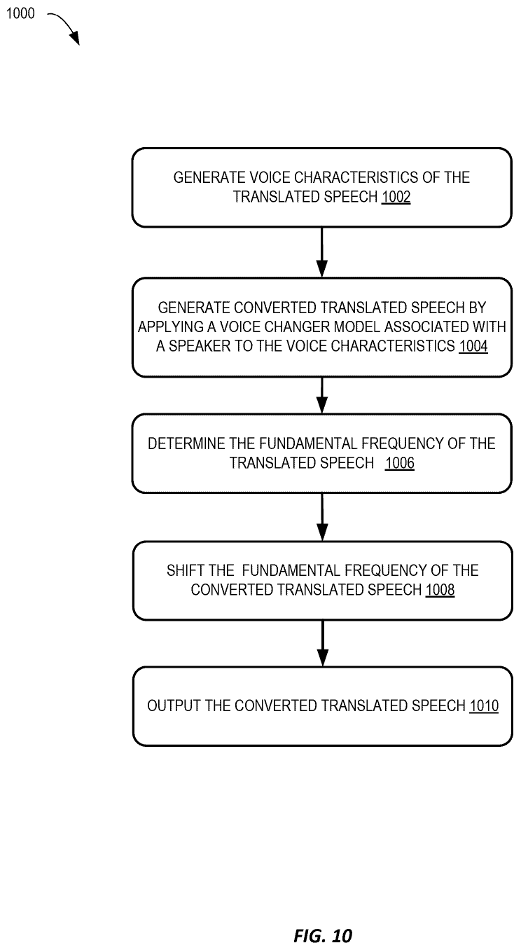

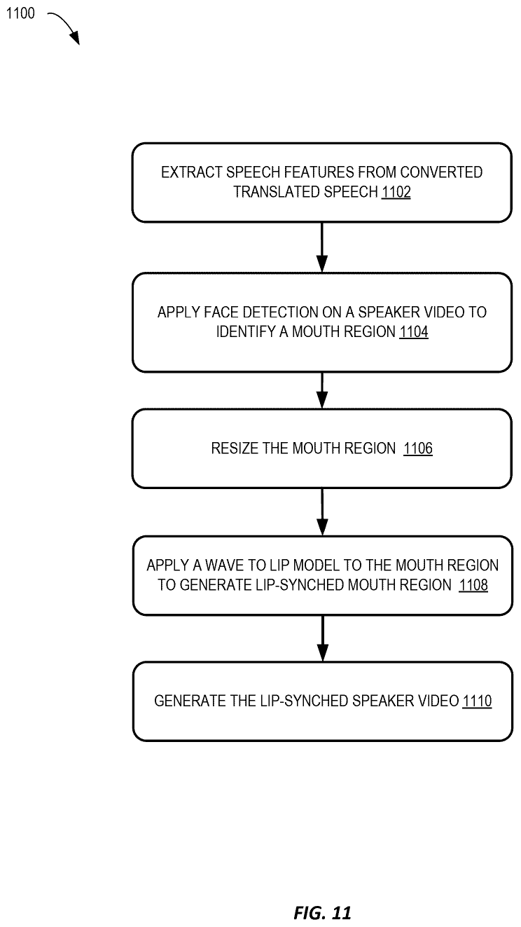

At block 904, the process 900 involves generating a converted translated speech using an audio conversion model, such as through a process shown in FIG. 10. At block 906, the process 900 involves generating a lip-synched speaker video using a video conversion model, such as through a process shown in FIG. 11.

At block 908, the process 900 involves transmitting the converted translated speech and the lip-synched speaker video to the participants of the video conference who have subscribed to the foreign language. The transmission may be performed through the chat and video conference provider 402. At block 910, the process 900 involves determining if there is another foreign language selected by participants of the video conference. If so, the process 900 involves repeating the blocks 902-908 for the second foreign language; otherwise, the process 900 ends.

FIG. 10 shows a flowchart depicting a process 1000 for generating converted translated speech audio signal for a speaker in videoconferencing, according to certain aspects of the present disclosure. The speaker client computing device 404 or another computing device can be configured to implement operations depicted in FIG. 10 by executing suitable program code. The software or program code may be stored on a non-transitory storage medium (e.g., on a memory device). The process depicted in FIG. 10 and described below is intended to be illustrative and non-limiting. Although FIG. 10 depicts the various processing blocks occurring in a particular sequence or order, this is not intended to be limiting. In certain alternative embodiments, the blocks may be performed in some different order, or some blocks may also be performed in parallel. For illustrative purposes, the process 1000 is described with reference to certain examples depicted in the figures. Other implementations, however, are possible.

At block 1002, the process 1000 involves generating voice characteristics of the translated speech. The audio conversion model can include a voice encoder (e.g., voice encoder 602) configured to encode the translated speech into values that represent voice characteristics, such as the voice intonation and timbre. In some examples, the translated speech is preprocessed, such as resampled, in order to provide it to the voice encoder as an input. The voice encoder extracts voice characteristics of the input speech while preserving the content and language characteristics of the speech.

At block 1004, the process 1000 involves generating converted translated speech by applying a voice changer model (e.g., voice changer model 604) associated with the speaker to the voice characteristics. The voice changer model is trained for the speaker and thus is configured to convert the input voice characteristics into voice characteristics of the speaker and to output a speech audio carrying the converted voice characteristics emulating the speaker's voice.

At block 1006, the process 1000 involves determining the fundamental frequency of the translated speech, such as by using a fundamental frequency determiner (e.g., the fundamental frequency determiner 608). At block 1008, the process 1000 involves shifting the fundamental frequency of the converted translated speech to align with the fundamental frequency of the speaker to generate the converted translated speech audio signal. At block 1008, the process 1000 involves outputting the converted translated speech audio signal.

FIG. 11 shows a flowchart depicting a process 1100 for generating lip-synched speaker video for videoconferencing, according to certain aspects of the present disclosure. The speaker client computing device 404 or another computing device can be configured to implement operations depicted in FIG. 11 by executing suitable program code. The software or program code may be stored on a non-transitory storage medium (e.g., on a memory device). The process depicted in FIG. 11 and described below is intended to be illustrative and non-limiting. Although FIG. 11 depicts the various processing blocks occurring in a particular sequence or order, this is not intended to be limiting. In certain alternative embodiments, the blocks may be performed in some different order, or some blocks may also be performed in parallel. For illustrative purposes, the process 1100 is described with reference to certain examples depicted in the figures. Other implementations, however, are possible.

At block 1102, the process 1100 involves extracting speech features from the converted translated speech generated by the audio conversion model. The extraction can be performed by a feature extractor (e.g., the feature extractor 702) and the speech features can be frequency domain features of the converted translated speech. The feature extractor may have a specific resolution requirement for the input signal. In that case, the converted translated speech is resampled to match the input resolution before being fed into the feature extractor.

At block 1104, the process 1100 involves applying face detection on a speaker video to identify the mouth region in the speaker video. The face detection can be implemented by a face detector (e.g., the face detector 704) to detect and track the facial features in the speaker video and output the mouth region. At block 1106, the process 1100 involves resizing the mouth region to match the input resolution of a wave to lip model (e.g., the wave to lip model 706) for generating the lip-synched mouth region. In some examples, the input of the wave to lip model has a lower resolution and thus the identified mouth region needs to be down sampled to match the input resolution. To reduce the artifacts around the mouth region of the final lip-synched speaker video, the mouth region can be enlarged or expanded to include additional pixels around the mouth region. For example, the mouth region can be enlarged or expanded by 5 pixels along four directions (left, right, upper, and lower) to generate the input mouth region to the wave to lip model.

At block 1108, the process 1100 involves applying the wave to lip model to the mouth region to generate lip-synched mouth region. As discussed above, the wave to lip model is configured to output a video of the mouth region based on the lip region and the speech features of the converted translated speech audio signal. In the output video of the mouth region, the lip movements match the audio content of the converted translated speech audio signal.

At block 1110, the process 1100 involves generating the lip-synched speaker video. To generate the lip-synched speaker video, a video reconstructor (e.g., the video reconstructor 708) can merge the lip-synched mouth region with the rest of the speaker video to generate lip-synched speaker video. The merging can include, for example, a linear or non-linear combination of the pixels at the border of the lip-synched mouth region with the corresponding pixels in the speaker video to reduce noticeable artifacts around the mouth region in the lip-synched speaker video.

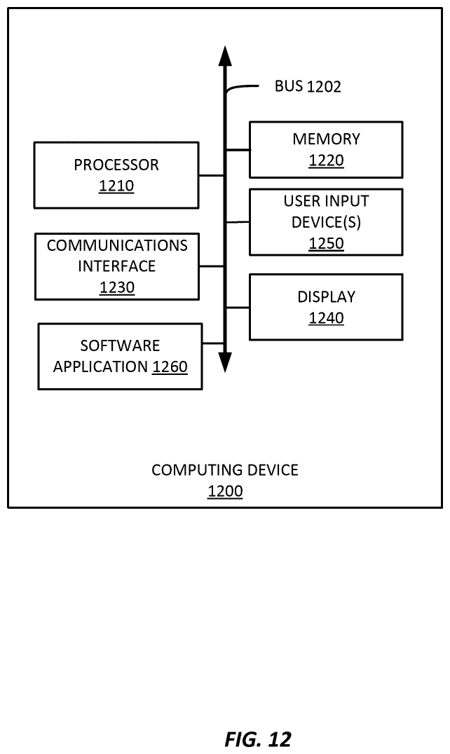

Referring now to FIG. 12, FIG. 12 shows an example computing device 1200 suitable for performing certain aspects of the present disclosure. The example computing device 1200 includes a processor 810 which is in communication with the memory 1220 and other components of the computing device 800 using one or more communications buses 1202. The processor 1210 is configured to execute processor-executable instructions stored in the memory 1220 to perform one or more processes described herein, such as part or all of the example process 900, 1000, or 1100 described above with respect to FIGS. 9, 10, and 11, respectively. For example, the software application 1260 provided on the computing device 1200 may provide instructions for performing one or more steps of the processes 900, 1000, or 1100. The computing device, in this example, also includes one or more user input devices 1250, such as a keyboard, mouse, touchscreen, video input device (e.g., one or more cameras), microphone, etc., to accept user input. The computing device 1200 also includes a display 1240 to provide visual output to a user.

The computing device 1200 also includes a communications interface 1230. In some examples, the communications interface 1230 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example, one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage devices capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example #1: a method performed by a computing device, the method comprising: accessing a speaker speech audio signal comprising a speaker speech in a first language captured at a client computing device associated with a speaker of a video conference and a video of the speaker associated with the speaker speech; accessing a translated speech audio signal, the translated speech audio signal comprising a speech in a second language that is a translation of the speaker speech; generating a converted translated speech audio signal based on the translated speech audio signal, the converted translated speech audio signal comprising a speech in the second language having voice characteristics in the speaker speech; generating a lip-synched speaker video based on the video of the speaker and the converted translated speech audio signal, wherein lip movements in the lip-synched speaker video correspond to the converted translated speech audio signal; and transmitting the converted translated speech audio signal and the lip-synched speaker video to a video conference provider configured to host the video conference.

Example #2: the method of Example #1, wherein generating the converted translated speech audio signal comprises: resampling the translated speech audio signal; encoding the translated speech audio signal into voice characteristics; applying a voice changer model onto the voice characteristics to generate the converted translated speech audio signal, wherein the voice changer model is associated with the speaker and is configured to change voice characteristics of an input speech audio signal to voice characteristics of the speaker; and outputting the converted translated speech audio signal.

Example #3: the method of Examples #1-2, wherein generating the converted translated speech audio signal further comprises: generating a fundamental frequency of the translated speech audio signal; and prior to outputting the converted translated speech audio signal, shifting a fundamental frequency of the converted translated speech audio signal based on a difference between a fundamental frequency of the converted translated speech audio signal and the fundamental frequency of the translated speech audio signal.

Example #4: the method of Examples #1-3, wherein the voice changer model is trained by a training process comprising: accessing training speaker speech audio signals; determining a quality score of the training speaker speech audio signals; processing the training speaker speech audio signals to increase the quality score based on determining that the quality score is lower than a predetermined threshold value; determining a fundamental frequency of the training speaker speech audio signals; and training the voice changer model by adjusting parameters of the voice changer model according to voice characteristics of the training speaker speech audio signal.

Example #5: the method of Examples #1-4, wherein generating the lip-synched speaker video based on the video of the speaker and the converted translated speech audio signal comprises: extracting speech features from the converted translated speech audio signal; performing face detection on the video of the speaker to identify a mouth region of the video; and modifying, via a machine learning model, the mouth region of the video according to the speech features to generate the lip-synched speaker video.

Example #6: the method of Examples #1-5, wherein generating the lip-synched speaker video based on the video of the speaker and the converted translated speech audio signal further comprises: resizing the mouth region before modifying, via the machine learning model, the mouth region by one or more of resampling the mouth region or expanding the mouth region by including pixels surrounding the identified mouth region; and wherein modifying, via the machine learning model, the mouth region of the video according to the speech features to generate the lip-synched speaker video comprises: applying the machine learning model to the resized mouth region to generate a lip-synched mouth region; and constructing the lip-synched speaker video by at least resizing the lip-synched mouth region and inserting the lip-synched mouth region into the video of the speaker.

Example #7: the method of Examples #1-6, wherein the translated speech audio signal is one or more of an interpreter speech audio signal or a computer-generated speech audio signal.

Example #8: a computing device, comprising: a non-transitory computer-readable medium; and a processor communicatively coupled to the non-transitory computer-readable medium, the processor configured to execute processor-executable instructions stored in the non-transitory computer-readable medium to: access a speaker speech audio signal comprising a speaker speech in a first language captured at a client computing device associated with a speaker of a video conference and a video of the speaker associated with the speaker speech; access a translated speech audio signal, the translated speech audio signal comprising a speech in a second language that is a translation of the speaker speech; generate a converted translated speech audio signal based on the translated speech audio signal, the converted translated speech audio signal comprising a speech in the second language having voice characteristics in the speaker speech; generate a lip-synched speaker video based on the video of the speaker and the converted translated speech audio signal, wherein lip movements in the lip-synched speaker video correspond to the converted translated speech audio signal; and transmit the converted translated speech audio signal and the lip-synched speaker video to a video conference provider configured to host the video conference.

Example #9: the computing device of Example #8, wherein generating the converted translated speech audio signal comprises: resampling the translated speech audio signal; encoding the translated speech audio signal into voice characteristics; applying a voice changer model onto the voice characteristics to generate the converted translated speech audio signal, wherein the voice changer model is associated with the speaker and is configured to change voice characteristics of an input speech audio signal to voice characteristics of the speaker; and outputting the converted translated speech audio signal.

Example #10: the computing device of Examples #8-9, wherein generating the converted translated speech audio signal further comprises: generating a fundamental frequency of the translated speech audio signal; and prior to outputting the converted translated speech audio signal, shifting a fundamental frequency of the converted translated speech audio signal based on a difference between a fundamental frequency of the converted translated speech audio signal and the fundamental frequency of the translated speech audio signal.

Example #11: the computing device of Examples #8-10, wherein the voice changer model is trained by a training process comprising: accessing training speaker speech audio signals; determining a quality score of the training speaker speech audio signals; processing the training speaker speech audio signals to increase the quality score based on determining that the quality score is lower than a predetermined threshold value; determining a fundamental frequency of the training speaker speech audio signals; and training the voice changer model by adjusting parameters of the voice changer model according to voice characteristics of the training speaker speech audio signal.

Example #12: the computing device of Examples #8-11, wherein generating the lip-synched speaker video based on the video of the speaker and the converted translated speech audio signal comprises: extracting speech features from the converted translated speech audio signal; performing face detection on the video of the speaker to identify a mouth region of the video; and modifying, via a machine learning model, the mouth region of the video according to the speech features to generate the lip-synched speaker video.

Example #13: the computing device of Examples #8-12, wherein generating the lip-synched speaker video based on the video of the speaker and the converted translated speech audio signal further comprises: resizing the mouth region before modifying, via the machine learning model, the mouth region by one or more of resampling the mouth region or expanding the mouth region by including pixels surrounding the identified mouth region; and wherein modifying, via the machine learning model, the mouth region of the video according to the speech features to generate the lip-synched speaker video comprises: applying the machine learning model to the resized mouth region to generate a lip-synched mouth region; and constructing the lip-synched speaker video by at least resizing the lip-synched mouth region and inserting the lip-synched mouth region into the video of the speaker.

Example #14: the computing device of Examples #8-13, wherein the translated speech audio signal is one or more of an interpreter speech audio signal or a computer-generated speech audio signal.

Example #15: a non-transitory computer-readable medium comprising processor-executable instructions configured to cause one or more processors to: access a speaker speech audio signal comprising a speaker speech in a first language captured at a client computing device associated with a speaker of a video conference and a video of the speaker associated with the speaker speech; access a translated speech audio signal, the translated speech audio signal comprising a speech in a second language that is a translation of the speaker speech; generate a converted translated speech audio signal based on the translated speech audio signal, the converted translated speech audio signal comprising a speech in the second language having voice characteristics in the speaker speech; generate a lip-synched speaker video based on the video of the speaker and the converted translated speech audio signal, wherein lip movements in the lip-synched speaker video correspond to the converted translated speech audio signal; and transmit the converted translated speech audio signal and the lip-synched speaker video to a video conference provider configured to host the video conference.

Example #16: the non-transitory computer-readable medium of Example #15, wherein generating the converted translated speech audio signal comprises: resampling the translated speech audio signal; encoding the translated speech audio signal into voice characteristics; applying a voice changer model onto the voice characteristics to generate the converted translated speech audio signal, wherein the voice changer model is associated with the speaker and is configured to change voice characteristics of an input speech audio signal to voice characteristics of the speaker; and outputting the converted translated speech audio signal.

Example #17: the non-transitory computer-readable medium of Examples #15-16, wherein generating the converted translated speech audio signal further comprises: generating a fundamental frequency of the translated speech audio signal; and prior to outputting the converted translated speech audio signal, shifting a fundamental frequency of the converted translated speech audio signal based on a difference between a fundamental frequency of the converted translated speech audio signal and the fundamental frequency of the translated speech audio signal.

Example #18: the non-transitory computer-readable medium of Examples #15-17, wherein the voice changer model is trained by a training process comprising: accessing training speaker speech audio signals; determining a quality score of the training speaker speech audio signals; processing the training speaker speech audio signals to increase the quality score based on determining that the quality score is lower than a predetermined threshold value; determining a fundamental frequency of the training speaker speech audio signals; and training the voice changer model by adjusting parameters of the voice changer model according to voice characteristics of the training speaker speech audio signal.

Example #19: the non-transitory computer-readable medium of Examples #15-18, wherein generating the lip-synched speaker video based on the video of the speaker and the converted translated speech audio signal comprises: extracting speech features from the converted translated speech audio signal; performing face detection on the video of the speaker to identify a mouth region of the video; and modifying, via a machine learning model, the mouth region of the video according to the speech features to generate the lip-synched speaker video.

Example #20: the non-transitory computer-readable medium of Examples #15-19, wherein generating the lip-synched speaker video based on the video of the speaker and the converted translated speech audio signal further comprises: resizing the mouth region before modifying, via the machine learning model, the mouth region by one or more of resampling the mouth region or expanding the mouth region by including pixels surrounding the identified mouth region; and wherein modifying, via the machine learning model, the mouth region of the video according to the speech features to generate the lip-synched speaker video comprises: applying the machine learning model to the resized mouth region to generate a lip-synched mouth region; and constructing the lip-synched speaker video by at least resizing the lip-synched mouth region and inserting the lip-synched mouth region into the video of the speaker.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method performed by a computing device, the method comprising:
accessing a speaker speech audio signal comprising a speaker speech in a first language captured at a client computing device associated with a speaker of a video conference and a video of the speaker associated with the speaker speech;
accessing a translated speech audio signal, the translated speech audio signal comprising a speech in a second language that is a translation of the speaker speech;
generating a converted translated speech audio signal based on the translated speech audio signal, the converted translated speech audio signal comprising a speech in the second language having voice characteristics in the speaker speech;
generating a lip-synched speaker video based on the video of the speaker and the converted translated speech audio signal, wherein lip movements in the lip-synched speaker video correspond to the converted translated speech audio signal; and
transmitting the converted translated speech audio signal and the lip-synched speaker video to a video conference provider configured to host the video conference.

2. The method of claim 1, wherein generating the converted translated speech audio signal comprises:
resampling the translated speech audio signal;
encoding the translated speech audio signal into voice characteristics;
applying a voice changer model onto the voice characteristics to generate the converted translated speech audio signal, wherein the voice changer model is associated with the speaker and is configured to change voice characteristics of an input speech audio signal to voice characteristics of the speaker; and
outputting the converted translated speech audio signal.

3. The method of claim 2, wherein generating the converted translated speech audio signal further comprises:
generating a fundamental frequency of the translated speech audio signal; and
prior to outputting the converted translated speech audio signal, shifting a fundamental frequency of the converted translated speech audio signal based on a difference between a fundamental frequency of the converted translated speech audio signal and the fundamental frequency of the translated speech audio signal.

4. The method of claim 2, wherein the voice changer model is trained by a training process comprising:
accessing training speaker speech audio signals;
determining a quality score of the training speaker speech audio signals;
processing the training speaker speech audio signals to increase the quality score based on determining that the quality score is lower than a predetermined threshold value;
determining a fundamental frequency of the training speaker speech audio signals; and
training the voice changer model by adjusting parameters of the voice changer model according to voice characteristics of the training speaker speech audio signal.

5. The method of claim 1, wherein generating the lip-synched speaker video based on the video of the speaker and the converted translated speech audio signal comprises:
extracting speech features from the converted translated speech audio signal;
performing face detection on the video of the speaker to identify a mouth region of the video; and
modifying, via a machine learning model, the mouth region of the video according to the speech features to generate the lip-synched speaker video.

6. The method of claim 5, wherein generating the lip-synched speaker video based on the video of the speaker and the converted translated speech audio signal further comprises:
resizing the mouth region before modifying, via the machine learning model, the mouth region by one or more of resampling the mouth region or expanding the mouth region by including pixels surrounding the identified mouth region; and
wherein modifying, via the machine learning model, the mouth region of the video according to the speech features to generate the lip-synched speaker video comprises:
applying the machine learning model to the resized mouth region to generate a lip-synched mouth region; and
constructing the lip-synched speaker video by at least resizing the lip-synched mouth region and inserting the lip-synched mouth region into the video of the speaker.

7. The method of claim 1, wherein the translated speech audio signal is one or more of an interpreter speech audio signal or a computer-generated speech audio signal.

8. A computing device, comprising:
a non-transitory computer-readable medium; and
a processor communicatively coupled to the non-transitory computer-readable medium, the processor configured to execute processor-executable instructions stored in the non-transitory computer-readable medium to:
access a speaker speech audio signal comprising a speaker speech in a first language captured at a client computing device associated with a speaker of a video conference and a video of the speaker associated with the speaker speech;
access a translated speech audio signal, the translated speech audio signal comprising a speech in a second language that is a translation of the speaker speech;
generate a converted translated speech audio signal based on the translated speech audio signal, the converted translated speech audio signal comprising a speech in the second language having voice characteristics in the speaker speech;
generate a lip-synched speaker video based on the video of the speaker and the converted translated speech audio signal, wherein lip movements in the lip-synched speaker video correspond to the converted translated speech audio signal; and
transmit the converted translated speech audio signal and the lip-synched speaker video to a video conference provider configured to host the video conference.

9. The computing device of claim 8, wherein generating the converted translated speech audio signal comprises:
resampling the translated speech audio signal;
encoding the translated speech audio signal into voice characteristics;
applying a voice changer model onto the voice characteristics to generate the converted translated speech audio signal, wherein the voice changer model is associated with the speaker and is configured to change voice characteristics of an input speech audio signal to voice characteristics of the speaker; and
outputting the converted translated speech audio signal.

10. The computing device of claim 9, wherein generating the converted translated speech audio signal further comprises:
generating a fundamental frequency of the translated speech audio signal; and
prior to outputting the converted translated speech audio signal, shifting a fundamental frequency of the converted translated speech audio signal based on a difference between a fundamental frequency of the converted translated speech audio signal and the fundamental frequency of the translated speech audio signal.

11. The computing device of claim 9, wherein the voice changer model is trained by a training process comprising:
accessing training speaker speech audio signals;
determining a quality score of the training speaker speech audio signals;
processing the training speaker speech audio signals to increase the quality score based on determining that the quality score is lower than a predetermined threshold value;
determining a fundamental frequency of the training speaker speech audio signals; and
training the voice changer model by adjusting parameters of the voice changer model according to voice characteristics of the training speaker speech audio signal.

12. The computing device of claim 8, wherein generating the lip-synched speaker video based on the video of the speaker and the converted translated speech audio signal comprises:
extracting speech features from the converted translated speech audio signal;
performing face detection on the video of the speaker to identify a mouth region of the video; and
modifying, via a machine learning model, the mouth region of the video according to the speech features to generate the lip-synched speaker video.

13. The computing device of claim 12, wherein generating the lip-synched speaker video based on the video of the speaker and the converted translated speech audio signal further comprises:
resizing the mouth region before modifying, via the machine learning model, the mouth region by one or more of resampling the mouth region or expanding the mouth region by including pixels surrounding the identified mouth region; and
wherein modifying, via the machine learning model, the mouth region of the video according to the speech features to generate the lip-synched speaker video comprises:
applying the machine learning model to the resized mouth region to generate a lip-synched mouth region; and
constructing the lip-synched speaker video by at least resizing the lip-synched mouth region and inserting the lip-synched mouth region into the video of the speaker.

14. The computing device of claim 8, wherein the translated speech audio signal is one or more of an interpreter speech audio signal or a computer-generated speech audio signal.

15. A non-transitory computer-readable medium comprising processor-executable instructions configured to cause one or more processors to:
access a speaker speech audio signal comprising a speaker speech in a first language captured at a client computing device associated with a speaker of a video conference and a video of the speaker associated with the speaker speech;
access a translated speech audio signal, the translated speech audio signal comprising a speech in a second language that is a translation of the speaker speech;
generate a converted translated speech audio signal based on the translated speech audio signal, the converted translated speech audio signal comprising a speech in the second language having voice characteristics in the speaker speech;
generate a lip-synched speaker video based on the video of the speaker and the converted translated speech audio signal, wherein lip movements in the lip-synched speaker video correspond to the converted translated speech audio signal; and
transmit the converted translated speech audio signal and the lip-synched speaker video to a video conference provider configured to host the video conference.

16. The non-transitory computer-readable medium of claim 15, wherein generating the converted translated speech audio signal comprises:
resampling the translated speech audio signal;
encoding the translated speech audio signal into voice characteristics;
applying a voice changer model onto the voice characteristics to generate the converted translated speech audio signal, wherein the voice changer model is associated with the speaker and is configured to change voice characteristics of an input speech audio signal to voice characteristics of the speaker; and
outputting the converted translated speech audio signal.

17. The non-transitory computer-readable medium of claim 16, wherein generating the converted translated speech audio signal further comprises:
generating a fundamental frequency of the translated speech audio signal; and
prior to outputting the converted translated speech audio signal, shifting a fundamental frequency of the converted translated speech audio signal based on a difference between a fundamental frequency of the converted translated speech audio signal and the fundamental frequency of the translated speech audio signal.

18. The non-transitory computer-readable medium of claim 16, wherein the voice changer model is trained by a training process comprising:
accessing training speaker speech audio signals;
determining a quality score of the training speaker speech audio signals;
processing the training speaker speech audio signals to increase the quality score based on determining that the quality score is lower than a predetermined threshold value;
determining a fundamental frequency of the training speaker speech audio signals; and
training the voice changer model by adjusting parameters of the voice changer model according to voice characteristics of the training speaker speech audio signal.

19. The non-transitory computer-readable medium of claim 15, wherein generating the lip-synched speaker video based on the video of the speaker and the converted translated speech audio signal comprises:
extracting speech features from the converted translated speech audio signal;
performing face detection on the video of the speaker to identify a mouth region of the video; and
modifying, via a machine learning model, the mouth region of the video according to the speech features to generate the lip-synched speaker video.

20. The non-transitory computer-readable medium of claim 19, wherein generating the lip-synched speaker video based on the video of the speaker and the converted translated speech audio signal further comprises:
resizing the mouth region before modifying, via the machine learning model, the mouth region by one or more of resampling the mouth region or expanding the mouth region by including pixels surrounding the identified mouth region; and
wherein modifying, via the machine learning model, the mouth region of the video according to the speech features to generate the lip-synched speaker video comprises:
applying the machine learning model to the resized mouth region to generate a lip-synched mouth region; and
constructing the lip-synched speaker video by at least resizing the lip-synched mouth region and inserting the lip-synched mouth region into the video of the speaker.
